(19) United States
(12) Patent Application Publication
(10) Pub. No.: US 2026/0251246 A1
(43) Pub. Date: Aug. 27, 2026

(54) FLUIDIC CONNECTION DEVICE FOR A FLUID CIRCUIT

(71) Applicant: HUTCHINSON, CLICHY (FR)

(72) Inventors: Stéphane LESTIENNE, Chateauneuf sur Loire (FR); Alexandre HOUSSIN, La Selle sur le Bied (FR)

(21) Appl. No.: 19/545,365

(22) Filed: Feb. 20, 2026

(30) Foreign Application Priority Data
Feb. 24, 2025 (FR) 2501856

(51) Int. Cl. F16L 23/02

(52) U.S. Cl. CPC F16L 23/02

(57) ABSTRACT

The disclosure relates to a fluidic connection device for a fluid circuit. The fluid connection device comprises a first connecting flange, a support plate, a transfer olive carried by the plate, and an attachment screw. The olive is mounted with an axial clearance (J) in an orifice in the plate.

### CROSS-REFERENCE TO RELATED APPLICATIONS

This present application claims priority to French Patent Application No. 2501856, filed February 24, 2025, the disclosure of which is hereby incorporated by reference in its entirety.

### TECHNICAL FIELD

The disclosure relates to a fluidic connection device for a fluid circuit, as well as a fluid circuit, for example for air conditioning or power steering, for a vehicle, in particular a motor vehicle.

### TECHNICAL BACKGROUND

Generally speaking, the air conditioning and power steering circuits for motor vehicles are fitted with leak-tight connection devices for the fluids circulating in them between the facing ends of two tubes in these circuits which, in the particular case of air conditioning circuits using carbon dioxide at high pressure, generate leaks of this refrigerant which typically have to be of the order of 0.5 g of CO2 per year.

There has therefore been a long-standing attempt to improve these connection devices by using two connecting flanges to connect these tubes, which are assembled together by an offset tightening screw and which allow the tubes to communicate with each other by means of a transfer end piece mounted in a sealed manner in these flanges by means of a conical/spherical assembly which, as is well known, provides sealed contact circles.

For example, reference may be made to the document DE-U1-202 20 520 for a description of such a device, wherein the end piece is additionally mounted on frustoconical ends of these tubes via sealing gaskets.

The Applicant has also already proposed in the document EP-A1-2 103 857 a connection device in accordance with the preamble to claim 1. The use of an olive-shaped transfer end piece is particularly effective in ensuring a sealing as described above.

In practice, a transfer olive is currently dedicated to a conical/spherical type assembly and it has not been proposed to use it in other types of assembly. In particular, there are connecting flanges on the market which do not have a conical or frustoconical surface and which are not currently suitable for use with a transfer olive.

In other words, there is a need for a universal solution that would allow a first flange comprising a frustoconical surface cooperating with a transfer olive to be combined with any second flange. This second flange may be similar or identical to the first flange and comprise a frustoconical surface able to cooperate with the transfer olive, or may comprise a different surface adapted to cooperate with the olive to provide a sealing to the assembly.

The present disclosure provides a simple, effective and economical solution to this need.

### SUMMARY

The present disclosure provides a fluidic connection device for a fluid circuit, this connection device comprising:

a first connecting flange formed by a metal block and comprising two parallel faces, a first of these faces comprising a first orifice able to receive one end of a pipe, a second of these faces comprising a first housing which is in fluidic communication with the first orifice and which is aligned with this first orifice, the first housing comprising a frustoconical internal surface, the first flange further comprising a first passage,

a support plate which is able to be pressed against the second face of the first flange and which comprises a first orifice aligned with the first housing, the plate further comprising a second passage aligned with the first passage,

a transfer olive which is carried by the plate, this olive being engaged in the first orifice of the plate and comprising an external annular groove wherein an inner annular edge of the first orifice of the plate is engaged, the olive having a longitudinal axis and having a transverse median plane of symmetry, the olive comprising axial ends which are each able to be engaged in the first housing and to bear on the frustoconical surface, and an attachment screw which passes through the first and second passages,

characterized in that the annular groove of the olive has a thickness or axial dimension which is greater than a thickness of the inner edge of the plate so that the olive is mounted with an axial clearance in the first orifice of the plate and the olive may, when one of the axial ends of the olive is engaged in the first housing and bears on the frustoconical surface, adopt an axial position wherein its plane of symmetry is offset relative to a plane of the plate.

The particularity of the disclosure and of the connection device according to the disclosure is that its olive is mounted with clearance, in particular in the axis of the olive, in the orifice of the plate. This clearance gives the olive the ability to move axially in relation to the plate over a predetermined stroke. This stroke allows the plate and olive assembly to be mounted on several types of flange, and not just a flange whose housing for receiving the olive comprises a frustoconical bearing surface, which is advantageous. The plate and olive assembly therefore forms a universal assembly that may be used on many types and references of flange. The disclosure also avoids incorrect mounting of the plate and flange assembly between two flanges. If the housings of the two flanges are not of the same depth, the olive will be engaged more in one housing than in the other housing. Whichever face of the plate is applied against the second face of the flange comprising the smaller depth housing, for example, the olive will adjust its axial position in the orifice in the plate and it is not possible to achieve an incorrect positioning and an incorrect mounting of the assembly between the flanges.

The device according to the disclosure may comprise one or more of the following characteristics, considered independently or in combination with each other:

the device comprises a second connecting flange formed by a metal block and comprising two parallel faces, a first of these faces comprising a first orifice able to receive an end of another pipe, a second of these faces comprising a second housing which is in fluidic communication with the first orifice and which is aligned with this first orifice, the second flange further comprising a third passage;

the plate is able to be inserted between the second faces of the first and second flanges;

the axial ends of the olive are respectively engaged in the first and second housings of the first and second flanges;

the attachment screw passing through the first, second and third passages;

the second housing comprises a frustoconical internal surface, the axial ends of the olive bearing respectively on the frustoconical surfaces of the first and second housings;

the frustoconical surface of the second housing is situated at a distance from the second face of the second flange, which is greater than a distance between the frustoconical surface of the first housing and the second face of the first flange, these two distances being measured in the same direction perpendicular to the respective second faces;

the second housing comprises a cylindrical internal surface and a cylindrical axial bearing surface, one of the axial ends of the olive bearing on the frustoconical surface of the first housing, and the other of the axial ends of the olive being surrounded by the cylindrical surface and bearing axially on the cylindrical bearing surface of the second housing;

the other of the axial ends of the olive bears axially on the cylindrical bearing surface of the second housing via a radial face of this end

the cylindrical bearing surface is notched or comprises concentric annular ribs;

the thickness of the groove is at least 1.5 times greater than the thickness of the inner edge;

the thickness of the groove is at least 2 times greater than the thickness of the inner edge;

the thickness of the plate is constant;

the first flange comprises, on its second face, an indexing boss or flat surface that is able to cooperate with the plate in a complementary manner;

the boss or the flat surface has a thickness which represents between 75% and 100% of the thickness of the plate;

the olive has a capacity for elastic deformation by axial compression, by tightening said screw;

the plate is made of a material chosen from a metal alloy and an elastically deformable material;

the olive is made of a material chosen from a metal alloy and an elastically deformable material;

the olive is generally tubular in shape;

the or each block has a general parallelepiped shape;

the ends of the olive are preferably in the form of spherical portions and therefore each comprise an annular surface in the form of a spherical portion.

The present disclosure also relates to a fluid circuit, for example for air conditioning or power steering, for a vehicle, in particular a motor vehicle, comprising at least one device as described above.

### BRIEF DESCRIPTION OF THE FIGURES

The disclosure will be better understood and other details, characteristics and advantages of the present disclosure will become clearer from the following description made by way of non-limiting example and with reference to the attached drawings, wherein:

FIG. 1 is a schematic cross-sectional perspective view of a connection device in the prior art;

FIG. 2 is a schematic perspective view of an assembly comprising a support plate and a transfer olive, for a connection device according to the disclosure;

FIG. 3 is another schematic perspective view of the assembly shown in FIG. 2;

FIG. 4 is a schematic perspective view of a first connecting flange for a connecting device according to the invention;

FIG. 5 is a schematic perspective view of the assembly shown in FIGS. 2 and 3 with the flange shown in FIG. 4;

FIG. 6 is a schematic cross-sectional view of the assembly shown in FIGS. 2 and 3 with the flange shown in FIG. 4;

FIG. 7 is a schematic perspective view of a second connecting flange for the connecting device according to the disclosure;

FIG. 8 is a schematic cross-sectional view of the connection device according to the disclosure, comprising the assembly of FIGS. 2 and 3 and the flanges of FIGS. 4 and 7;

FIG. 9 is a schematic cross-sectional view of a variant of embodiment of the second connecting flange for the connecting device according to the disclosure;

FIG. 10 is a schematic perspective view and partial cross-section of the connection device according to the disclosure comprising the assembly of FIGS. 2 and 3 and the flanges of FIGS. 4 and 9; and

FIG. 11 is another schematic cross-sectional view of the connection device according to the disclosure, comprising the assembly of FIGS. 2 and 3 and the flanges of FIGS. 4 and 9.

### DETAILED DESCRIPTION

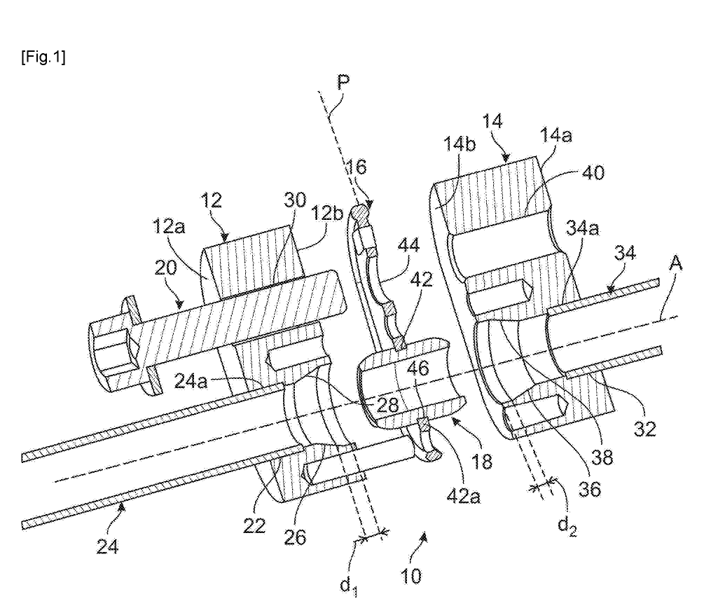

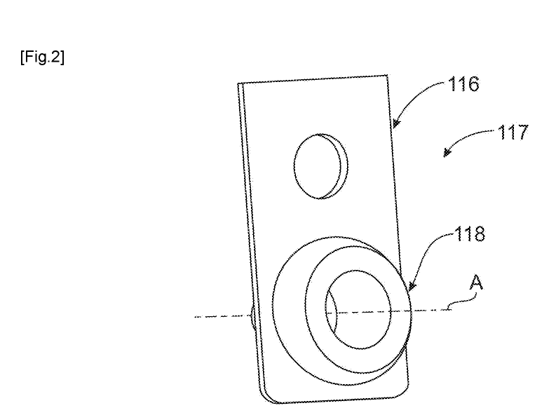

Reference is first made to FIG. 1, which shows a fluidic connection device 10 in accordance with the prior art, as described in the document EP-A1-2 103 857. The device 10 essentially comprises two connecting flanges 12, 14, a support plate 16, a transfer olive 18 carried by the plate 16, and a screw 20 for attaching or tightening the flanges 12, 14 together.

The first flange 12, on the left in the drawing, is formed by a metal block and comprises two parallel faces 12a, 12b. A first of these faces 12a comprises a first orifice 22 able to receive an end 24a of a pipe 24, in particular a metal pipe.

The second face 12b of the flange 12 comprises a first housing 26 which is in fluidic communication with the first orifice 22 and is aligned with this first orifice 22.

The first housing 26 comprises a frustoconical internal surface 28.

The first flange 12a also comprises a passage 30.

The second flange 14, on the right of the drawing, is formed by a metal block and comprises two parallel faces 14a, 14b. A first of these faces 14a comprises a first orifice 32 able to receive an end 34a of another pipe 34.

The second face 14b of the flange 14 comprises a second housing 36 which is in fluidic communication with the first orifice 32 and is aligned with this first orifice 32.

The second housing 36 comprises a frustoconical internal surface 38.

The second flange 36 also comprises a passage 40.

The plate 16 is inserted between the flanges 12, 14 and able to be applied against the faces 12b, 14b opposite these flanges 12, 14.

The plate 16 comprises a first orifice 42 aligned with the housings 26, 36 of the flanges 12, 14 and a passage 44 aligned with the passages 30, 40 of the flanges 12, 14.

The olive 18 is carried by the plate 16 and in particular engages in the orifice 42 of the plate 16. The olive 18 comprises an external annular groove 46 wherein an inner annular edge 42a of the orifice 42 of the plate 16 is engaged.

The olive 18 has a longitudinal axis A and a transverse median plane of symmetry P.

The olive 18 comprises axial ends which are engaged respectively in the housings 26, 36 of the flanges 12, 14 and which bear on the frustoconical surfaces 26a, 36a of these housings 26, 36.

The screw 20 passes through the passages 30, 40 and 44 and tightens the flanges 12,14 together.

In the connection device shown in FIG. 1, the olive 18 is mounted without clearance in the orifice 42 in the plate 16. The plate 16 extends in the plane P. Furthermore, the housings 26, 36 of the flanges 12, 14 are identical, the distances d1, d2 of their frustoconical surfaces 26a, 36a to the surfaces 12b, 14b being identical.

We will now describe an embodiment of a connection device 110 according to the disclosure.

In the context of the present disclosure, the connection device 110 is defined as comprising at least a flange, a support plate, a transfer olive and an attachment screw. As will be explained below, this connection device may comprise a second flange which may be of the same type as that of the first flange or of a different type.

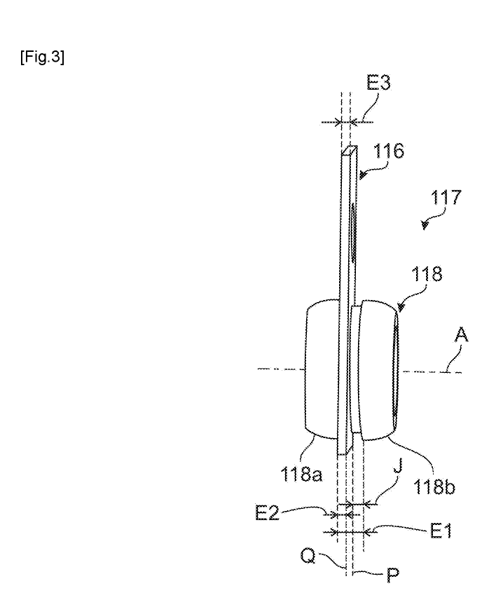

FIGS. 2 and 3 illustrate an embodiment of the assembly 117 formed by the support plate 116 and the transfer olive 118 of a connection device 110 in accordance with the disclosure.

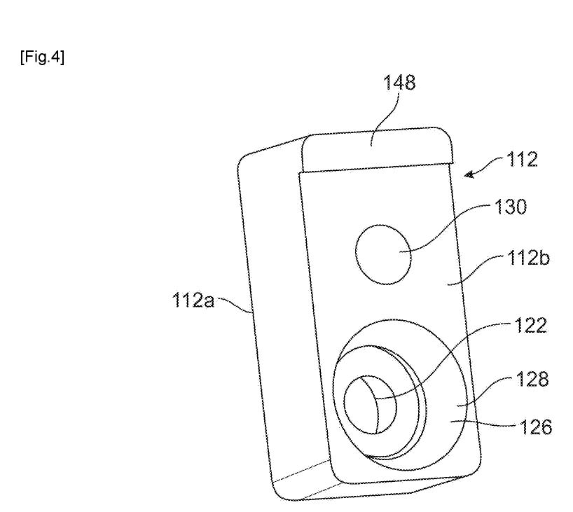

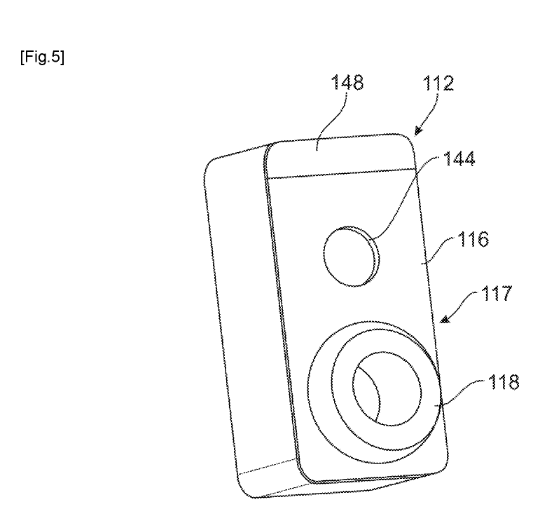

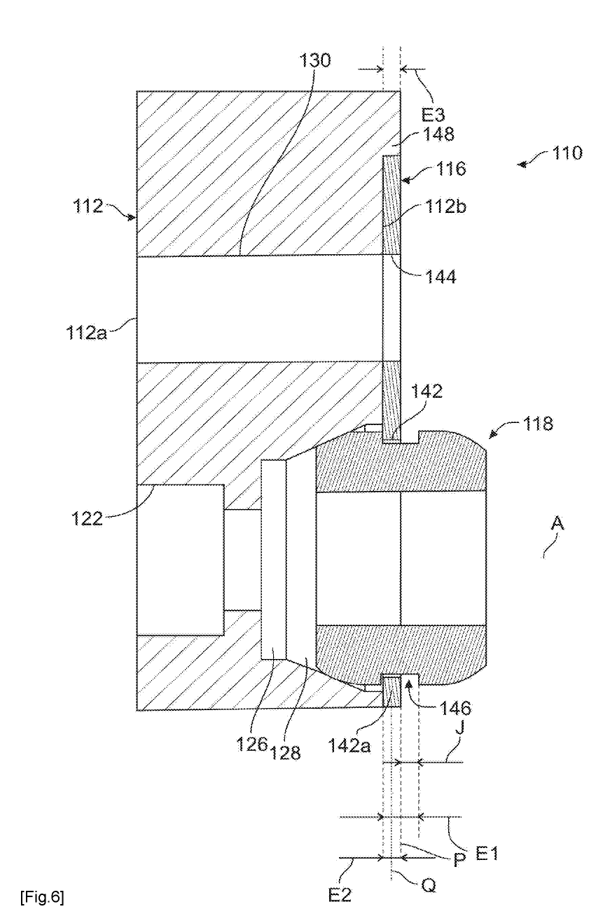

FIG. 4 shows an embodiment of the first flange 112 and FIGS. 5 and 6 show the assembly 117 and the first flange 112 in the assembled position.

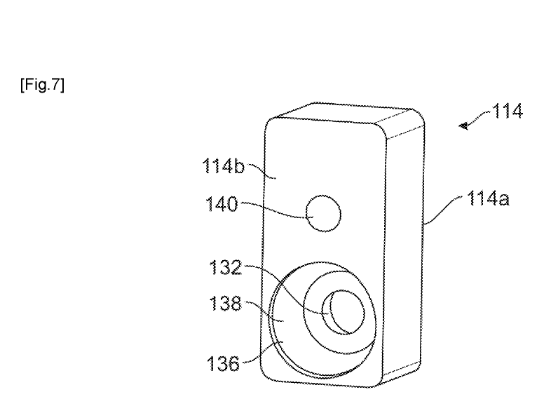

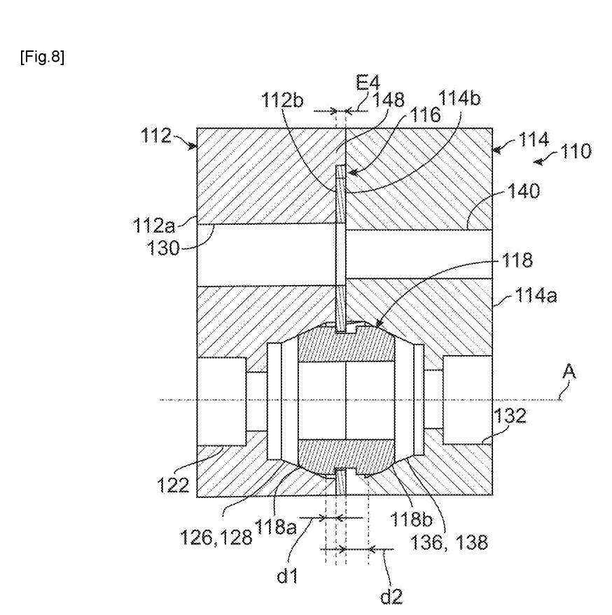

FIG. 7 shows an embodiment of the second flange 114 and FIG. 8 shows the assembly 117 and the flanges 112, 114 in the assembled position.

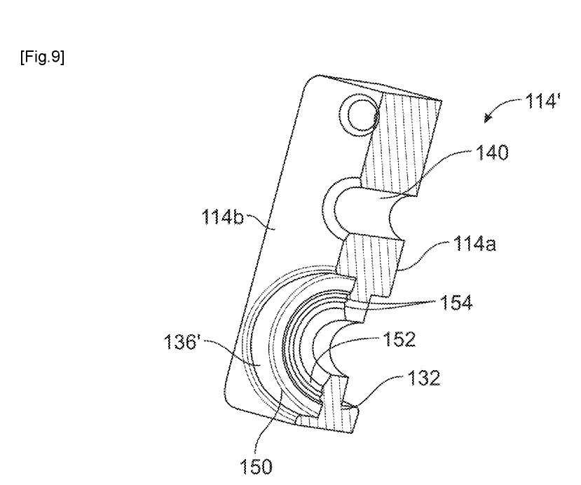

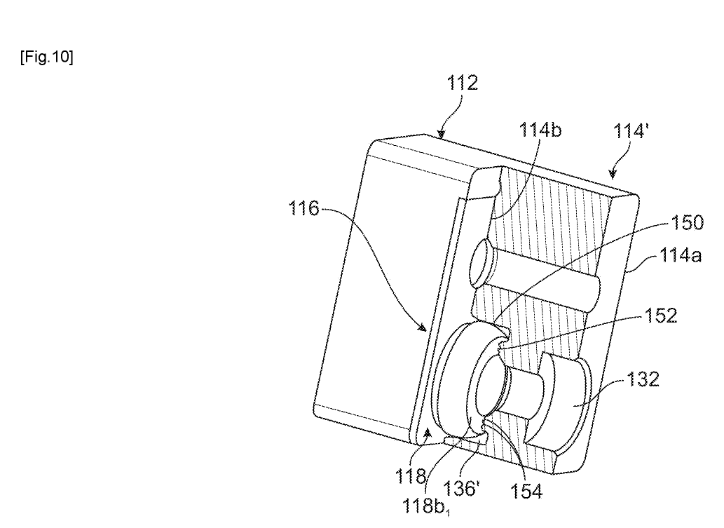

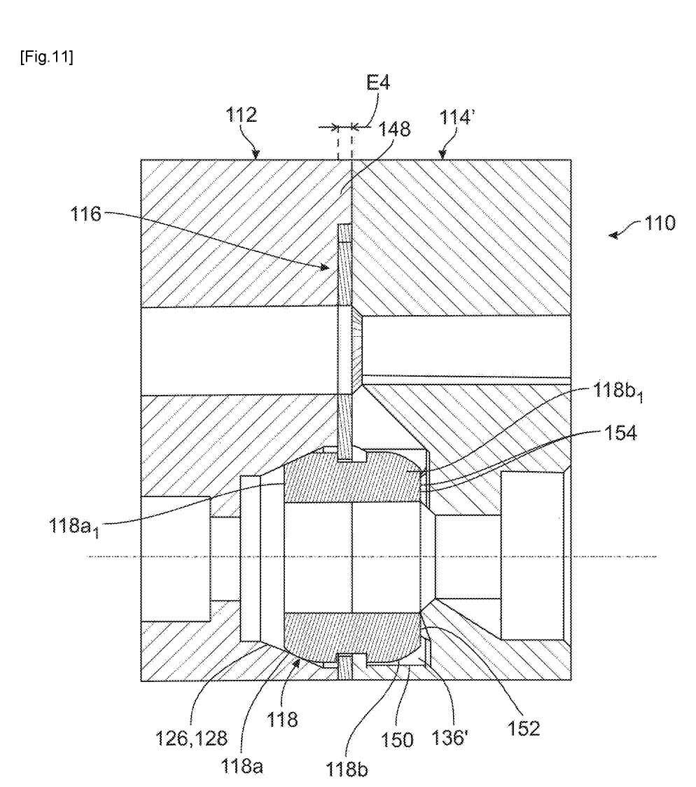

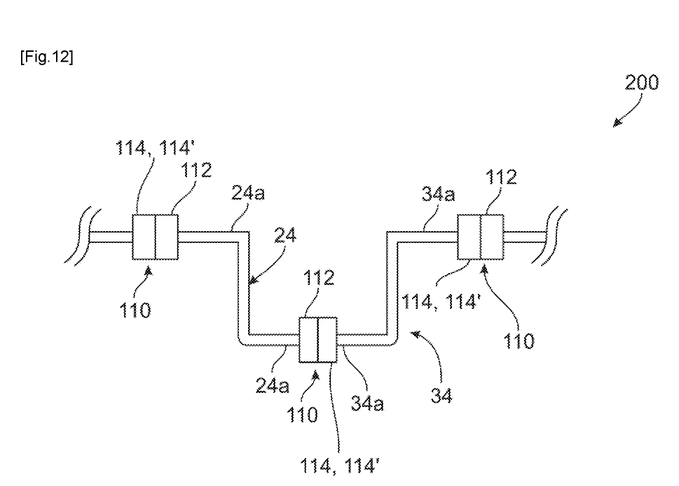

FIG. 9 shows a variant of embodiment of the second flange 114' and FIGS. 10 and 11 show the assembly 117 and the flanges 112, 114' in the assembled position.

The first flange 112 is formed by a metal block, for example a parallelepiped, and comprises two parallel faces 112a, 112b. A first of these faces 112a comprises a first orifice 122 able to receive an end 24a of a pipe 24, in particular a metal pipe, as shown in FIG. 1.

The second face 112b of the flange 112 comprises a first housing 126 which is in fluidic communication with the first orifice 122 and which is aligned with this first orifice 122.

The first housing 126 comprises a frustoconical internal surface 128.

The first flange 112a also comprises a passage 130.

The assembly 117 shown in FIGS. 2 and 3 comprises the transfer olive 118 and the support plate 116.

The plate 116 is configured to be pressed against the face 112b of the flange 112, as shown in FIGS. 4 and 5.

The plate 16 comprises a first orifice 142 aligned with the housing 126 of the flange 112 and a passage 144 aligned with the passage 30 of the flange.

The olive 118 is carried by the plate 116 and in particular engages in the orifice 142 of the plate 116. The olive 118 comprises an external annular groove 146 wherein an inner annular edge 142a of the orifice 142 of the plate 116 is engaged.

The olive 118 has a longitudinal axis A and a transverse median plane of symmetry P.

The olive 118 is generally tubular in shape.

The olive 118 comprises axial ends 118a, 118b, one of which is engaged in the housing 126 of the flange 112 and bears on the frustoconical surface 128 of this housing 126, as shown in FIG. 6.

The ends 118a, 118b are preferably portions of a sphere and therefore each comprise an annular surface centered on the axis A as a portion of a sphere.

The particularity of the groove 146 is that it has a thickness E1 or axial dimension which is greater than a thickness E2 of the inner edge 142a of the plate 116. In this way, the olive 118 is mounted with an axial clearance J in the orifice 142 in the plate 116. The olive 118 may thus, when its end 118a is engaged in the housing 126, bear on the surface 128 via this end 118a and adopt an axial position wherein its plane of symmetry P is offset relative to the plane Q of the plate 116 on the side opposite the flange 112, or conversely, when its end 118b is engaged in the housing 126, bear on the surface 142a via this end 118a and adopt an axial position wherein its plane of symmetry P is offset relative to the plane Q of the plate 116 on the side opposite the flange 112. In other words, the position of the olive 118 is adapted by the fact that it is axially displaceable in the orifice 142 of the plate 116.

The thickness E1 of the groove 146 is at least 1.5 times, if not 2 times, greater than the thickness E2 of the inner edge 142a.

The thickness E3 of the plate 116 may be constant and therefore the thickness E2 of the edge 142a is equal to the thickness E3 of the plate 116.

The frustoconical surface 128 of the housing 126 is located at a distance d1 from the face 112b of the flange 112, measured along the axis A.

Advantageously, the flange 112 comprises on its face 112b an indexing boss or flat surface 148 able to cooperate in a complementary manner with the plate 116 and in particular with a peripheral edge of the plate 116 as illustrated in FIGS. 5 and 6.

FIGS. 7 and 8 illustrate a first embodiment of the second flange 114.

The second flange 114 is formed by a metal block, for example a parallelepiped, and comprises two parallel faces 114a, 114b. A first of these faces 114a comprises a first orifice 132 able to receive an end 34a of another pipe 34, such as that shown in FIG. 1.

The second face 114b of the flange 114 comprises a second housing 136 which is in fluidic communication with the first orifice 132 and which is aligned with this first orifice 132.

The second flange 114 also comprises a passage 140.

It is understood that the plate 116 is able to be inserted between the faces 112b, 114b of the flanges 112, 114.

The axial ends of the olive 118 are respectively engaged in the housings 126, 136 of the flanges 112, 114.

An attachment screw 20, such as that shown in FIG. 1, passes through the passages 130, 140 and 144.

In the example shown, the second housing 136 comprises a frustoconical internal surface 138.

The axial ends 118a, 118b of the olive 118 bear respectively on the frustoconical surfaces 128, 138 of the housings 126, 136 (FIG. 8).

Preferably, the frustoconical surface 138 of the housing 136 is located at a distance d2 from the face 114b of the flange 114, which is greater than the distance d1. The distance d2 is measured along the axis A.

FIG. 8 therefore shows that the olive 118 is more engaged in the housing 136 than in the housing 126. Even if the assembly formed by the plate 116 and the olive 118 were mounted upside down, i.e. the end 118a would be engaged in the housing 136 and the end 118b would be engaged in the housing 126, the olive 118 would be more engaged in the housing 136 than in the housing 126 because of its capacity for axial translation inside the orifice 142 of the plate 116.

FIGS. 9 to 11 illustrate a second embodiment of the second flange 114'.

The flange 114' differs from the flange 114 described above essentially by its housing 136'.

In the example shown, the housing 136' comprises a cylindrical internal surface 150 and a cylindrical axial bearing surface 152.

One of the axial ends 118a of the olive 118 bears on the frustoconical surface 128 of the housing 126 of the flange 112, and the other of the axial ends 118b of the olive 118 is surrounded by the cylindrical surface 152 and bears axially on the cylindrical bearing surface 152.

FIGS. 10 and 11 show that the end 118b of the olive 118 bears axially on the cylindrical bearing surface 152 via a radial face 118b1 of this end 118b.

Preferably, the cylindrical bearing surface 152 is notched or comprises concentric annular ribs 154.

FIG. 11 therefore shows that the olive 118 is more closely engaged in the housing 136' than in the housing 126. Even if the assembly formed by the plate 116 and the olive 118 were mounted upside down, i.e. the end 118a would be engaged in the housing 136' and the end 118b would be engaged in the housing 126, the olive 118 would be further engaged in the housing 136' and would bear by a radial face 118a1 of its end 118a on the cylindrical bearing surface 152, due to its capacity for axial translation inside the orifice 142 of the plate 116.

The boss or the flat surface 148 preferably has a thickness E4 which represents between 75% and 100% of the thickness E3 of the plate 116. This allows the plate 116 to be tightened axially between the flanges 112, 114 or 112, 114', ensuring optimum sealing of the device 110.

The olive 118 has preferably an ability of elastic deformation by axial compression by tightening the screw 20.

The plate 116 may be made from a material selected from a metal alloy and an elastically deformable material. The plate 118 is preferably made of elastomer.

The olive 118 may be made of a material selected from a metal alloy and an elastically deformable material. The olive 118, for example, is made of a copper alloy coated with a zinc-based alloy.

In addition, the spherical shape of the end 118a of the olive 118, which bears on the frustoconical surface 128 of the housing 126 of the flange 112, allows a rotation which allows to compensate both for the lack of parallelism between the cylindrical bearing surface 152 and the bearing face of the boss or flat surface 148 and for the difference between the thickness E4 of the boss or flat surface 148 and the thickness E3 of the support plate 116.

FIG. 12 shows a very schematic example of a fluid circuit 200, for example for air conditioning or power steering, for a vehicle, in particular a motor vehicle, comprising one or more devices 110 as described above and connected to each other or to items of equipment (compressor, pump, etc.) in the circuit by pipes 24, 34.

1. A fluidic connection device for a fluid circuit, this connection device comprising:
a first connection flange formed by a metal block and comprising two parallel faces, a first of these faces comprising a first orifice able to receive one end of a pipe, a second of these faces comprising a first housing which is in fluidic communication with the first orifice and which is aligned with this first orifice, the first housing comprising a frustoconical internal surface, the first flange further comprising a first passage,
a support plate which is able to be pressed against the second face of the first flange and which comprises a first orifice aligned with the first housing, the plate further comprising a second passage aligned with the first passage,
a transfer olive which is carried by the plate, this olive being engaged in the first orifice of the plate and comprising an external annular groove wherein an inner annular edge of the first orifice of the plate is engaged, the olive having a longitudinal axis (A) and having a transverse median plane (P1) of symmetry, the olive comprising axial ends which are each able to be engaged in the first housing and to bear on the frustoconical surface, and
an attachment screw which passes through the first and second passages
wherein the annular groove of the olive has a thickness (El) or axial dimension which is greater than a thickness (E2) of the inner edge of the plate so that the olive is mounted with an axial clearance (J) in the first orifice of the plate and the olive may, when one of the axial ends of the olive is engaged in the first housing and bears on the frustoconical surface adopt an axial position wherein its plane of symmetry (P1) is offset relative to a plane (P) of the plate.

2. The device according to claim 1 comprising:
a second connecting flange formed by a metal block and comprising two parallel faces, a first of these faces comprising a first orifice able to receive one end of another pipe, a second of these faces comprising a second housing which is in fluidic communication with the first orifice and which is aligned with this first orifice, the second flange further comprising a third passage,
the plate being able to be inserted between the second faces (112b, 114b) of the first and second flanges,
the axial ends of the olive being respectively engaged in the first and second housings of the first and second flanges, and the attachment screw passing through the first, second and third passages.

3. The device according to claim 2, wherein the second housingcomprises a frustoconical internal surface the axial ends of the olivebearing respectively on the frustoconical surfaces of the first and second housings.

4. The device according to claim 3, wherein the frustoconical surface of the second housing is situated at a distance (d2) from the second faceof the second flange which is greater than a distance (dl) between the frustoconical surface of the first housing and the second face of the first flange these two distances (dl, d2) being measured in the
same direction perpendicular to the respective second faces.

5. The device according to claim 2, wherein the second housing comprises a cylindrical internal surface and a cylindrical axial bearing surface one of the axial ends of the olive bearing on the frustoconical surface of the first housing and the other of the axial ends of the olive being surrounded by the cylindrical surface and bearing axially on the cylindrical bearing surface of the second housing.

6. The device according to claim 5, wherein the other of the axial ends of the olive bears axially on the cylindrical bearing surface of the second housing via a radial face of this end.

7. The device according to claim 5, wherein the cylindrical bearing surface is notched or comprises concentric annular ribs.

8. The device according to claim 1, wherein the thickness (E1) of the groove is at least 1.5 times greater than the thickness (E2) of the inner edge.

9. The device according to claim 8, wherein the thickness (E1) of the groove is at least 2 times greater than the thickness (E2) of the inner edge.

10. The device according to claim 1, wherein the thickness (E3) of the plate is constant.

11. The device according to claim 1, wherein the first flange comprises, on its second face an indexing boss or flat surface able to cooperate with the plate in a complementary manner.

12. The device according to claim 11, wherein the boss or the flat surface has a thickness (E4) which represents between 75% and 100% of the thickness (E3) of the plate.

13. The device according to claim 1, wherein the olive has a capacity for elastic deformation by axial compression, by tightening said screw.

14. The device according to claim 1, wherein the plate is made of a material chosen from a metal alloy and an elastically deformable material.

15. The device according to claim 1, wherein the olive is made of a material chosen from a metal alloy and an elastically deformable material.

16. A fluid circuit for air conditioning or power steering for a vehicle comprising at least one device according to claim 1.

17. The device according to claim 5, wherein the cylindrical bearing surface is notched or comprises concentric annular ribs.
